(19) United States
(12) Patent Application Publication
(10) Pub. No.: US 2006/0187417 A1
(43) Pub. Date: Aug. 24, 2006

(54) Projector

(75) Inventors: Koichi Akiyama, Matsumoto-shi (JP); Masami Murata, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/304,542

(22) Filed: Dec. 16, 2005

(30) Foreign Application Priority Data
Feb. 21, 2005 (JP) 2005-043518

(51) Int. Cl. G03B 21/00

(52) U.S. Cl. 353/33

(57) ABSTRACT

A projector comprises an electro-optic modulator that modulates an illumination light beam in accordance with image information; a projecting optical system that projects the illumination light beam modulated by the electro-optic modulator, an illuminating device that emits the illumination light beam having a sectional shape compressed in the other direction so as to illuminate an entire image forming area with respect to one direction in the image forming area of the electro-optic modulator and illuminate one portion of the image forming area with respect to the other direction; and a rotating prism rotated at a constant speed and scanning the illumination light beam from the illuminating device along the other direction in the image forming area of the electro-optic modulator. The projector further comprises an illuminating device driving circuit that controls the light amount of the illumination light beam emitted from the illuminating device so as to reduce an illuminance difference generated by changing the scanning speed of the illumination light beam on the image forming area in the electro-optic modulator.

### BACKGROUND

The present invention can relate to a projector.

A projector for improving moving picture display quality by scanning an illumination light beam on an image forming area of a liquid crystal device is known (e.g., see JP-A-2004-325577).

FIG. 18 is a view shown to explain such a related art projector 900. FIG. 18A is a view showing an optical system of the related art projector 900. FIG. 18B is a view shown to explain the action of a rotating prism 960. FIG. 18C is a view showing a situation in which the illumination light beam is scanned on the image forming area of a liquid crystal device 970 by rotating the rotating prism 960. FIG. 19 is a view showing the rotating speed of the rotating prism 960 in the related art projector 900.

In the related art projector 900, as shown in FIG. 18, the illumination light beam L is scanned on the image forming area of the liquid crystal device 970 by rotating the rotating prism 960. Therefore, in accordance with the related art projector 900, light is intermittently interrupted if an arbitrary point in the image forming area of the liquid crystal device 970 is noticed. Therefore, the moving picture display quality are improved and excellent moving picture display quality are provided

Further, in accordance with the related art projector 900, as shown in FIG. 19, the illumination light beam L is scanned at an equal speed on the image forming area of the liquid crystal device 970 by changing the rotating speed of the rotating prism 960. Therefore, in accordance with the related art projector 900, an illuminance difference in the image forming area of the liquid crystal device 970 is reduced, and more uniform display can be performed on an entire projecting face. Namely, uniform in-plane display characteristics are provided

However, in the related art projector 900, it is necessary to precisely change the rotating speed of the rotating prism in a very short period. Therefore, it is necessary to use an expensive motor as a motor for operating the rotating prism, and a problem exists in that manufacture cost is raised. Further, in the related art projector 900, since it is necessary to change the rotating speed of the rotating prism in the very short period, it is necessary to frequently accelerate and decelerate the rotating speed of the motor for operating the rotating prism, and a problem exists in that electric power consumption is raised.

### SUMMARY

An advantage of some exemplary embodiments of the invention is to provide a projector having excellent moving picture display quality and uniform in-plane display characterstics and raising no manufacture cost and no electric power consumption.

A projector according to an exemplary embodiment of the invention can comprise: an electro-optic modulator that modulates an illumination light beam in accordance with image information; a projecting optical system that projects the illumination light beam modulated by the electro-optic modulator; an illuminating device that emits the illumination light beam having a sectional shape compressed in the other diction so as to illuminate an entire image forming area with respect to one direction in the image forming area of the electro-optic modulator and illuminate one portion of the image forming area with respect to the other direction; and a rotating prism rotated at a constant speed and that scans the illumination light beam from the illuminating device along the other direction in the image forming area of the electro-optic modulator. The projector can further comprise an illuminating device driving circuit that controls the light amount of the illumination light beam emitted from the illuminating device so as to reduce an illuminance difference generated by changing the scanning speed of the illumination light beam on the image forming area in the electro-optic modulator.

Therefore, in accordance with the exemplary projector of the invention, the illumination light beam is scanned on the image forming area of the electro-optic modulator by rotating the rotating prism. As a result, light is intermittently interrupted if an arbitrary point in the image forming area of the electro-optic modulator is noticed. Therefore, moving picture display quality are improved and excellent moving picture display quality are provided

Further, in accordance with the exemplary projector of the invention, the light amount of the illumination light beam can be controlled so as to reduce the above illuminance difference. Therefore, the illuminance difference generated when the rotating prism is rotated at a constant rotating speed is reduced (since the scanning speed of the illumination light beam in both end portions in the other direction in the image forming area of the electro-optic modulator is faster than the scanning speed of the illumination light beam in the central portion in the other direction, the illuminance in both the end portions in the other direction in the image forming area of the electro-optic modulator becomes lower than the illuminance in the central portion in the other direction). Thus, more uniform display can be performed on an entire projecting face. Namely, uniform in-plane display characteristics are provided. In this case, when the illumination light beam passes through the central portion in the other direction in the image forming area of the electro-optic modulator, control is performed such that the light amount of the illumination light beam emitted from the illuminating device is reduced. When the illumination light beam passes through both the end portions in the other direction in the image forming area of the elect optic modulator, control is also performed such that the light amount of the illumination light beam emitted from the illuminating device is increased

Further, in accordance with the exemplary projector of the invention, it is not necessary to change the rotating speed of the rotating prism in a very short period. Therefore, it is not necessary to use an expensive motor as a motor that operates the rotating prism. It is also not necessary to frequently accelerate and decelerate the rotating speed of the motor that operates the rotating prism. Therefore, no manufacture cost is raised and no electric power consumption is raised

Therefore, the exemplary projector of the invention becomes a projector having excellent moving picture display quality and uniform in-plane display characteristics, and raising no manufacture cost and no electric power consumption so that the advantage of the invention is achieved.

In the exemplary projector of the invention, it is preferable that the projector further comprises a rotating state detecting sensor that detects a rotating state of the rotating prism The illuminating device diving circuit controls the light amount of the illumination light beam emitted from the illuminating device on the basis of an output signal of the rotating state detecting sensor.

In accordance with such a construction, accurate control corresponding to the rotating state of the rotating prism can be performed. Therefore, it is possible to effectively reduce the illuminance difference generated by changing the scanning speed of the illumination light beam on the image forming area in the electro-optic modulator.

In the exemplary projector of the invention, it is preferable that the projector further comprises an image processing circuit that processes image information. The rotating prism is constructed so as to be rotated at a constant speed on the basis of a synchronous signal from the image processing circuit. The illuminating device driving circuit controls the light amount of the illumination light beam emitted from the illuminating device on the basis of the synchronous signal from the image processing circuit.

The rotating prism is rotated on the basis of the synchronous signal from the image processing circuit. Therefore, in accordance with the above construction, the accurate control corresponding to the rotating state of the rotating prism can also be performed. Therefore, it is possible to effectively reduce the illuminance difference generated by changing the scanning speed of the illumination light beam on the image forming area in the electro-optic modulator.

In the exemplary projector of the invention, it is preferable that the illuminating device has a light source device having a light emitting tube and a reflector and emitting the illumination light beam on the side of an illuminated area; a first lens array having plural first small lenses that divides the illumination light beam emitted from the light source device into plural partial light beams; a second lens array having plural second small lenses corresponding to the plural first small lenses of the first lens array; and a superposing lens that superposes each partial light beam emitted from the plural second small lenses of the second lens array on an illumination area. The first small lens has a planar shape compressed in the other direction.

In accordance with such a construction, the illumination light beam having the sectional shape compressed in the other direction and having a uniform in-plane illuminance distribution can be emitted by using the illuminating device constructed by the above lens integrator optical system so that light utilization efficiency can be improved. As a result, it is possible to construct a projector having excellent moving picture display quality and uniform in-plane display characteristics, and raising no manufacture cost and no electric power consumption.

In the exemplary projector of the invention, it is preferable that &e illuminating device has a light source device having a light emitting tube and an ellipsoidal reflector and emitting a convergent illumination light beam on the side of an illuminated area; and an integrator rod that converts the illumination light beam from the light source device into an illumination light beam having a more uniform intensity distribution. A light emitting face of the integrator rod has a planar shape compressed in the other direction.

In accordance with such a construction, the illumination light beam having the sectional shape compressed in the other direction and having a uniform in-plane illuminance distribution can be emitted by using the illuminating device constructed by the above rod integrator optical system so that light utilization efficiency can be improved. As a result, it is possible to construct a projector having excellent moving picture display quality and uniform in-plane display characteristics, and raising no manufacture cost and no electric power consumption

In the exemplary projector of the invention, it is preferable that the illuminating device driving circuit controls the light emitting amount of the light emitting tube.

In accordance with such a construction, the light amount of the illumination light beam emitted from the illuminating device can be easily controlled by controlling the light emitting amount of the light emitting tube.

In the exemplary projector of the invention, it is preferable that the illuminating device has an LED. The illuminating device driving circuit controls the light emitting amount of the LED.

In accordance with such a construction, the light amount of the illumination light beam emitted from the illuminating device can be easily controlled by controlling the light emitting amount of the LED.

In the exemplary projector of the invention, it is preferable that the projector further comprises a light shielding member that shapes the sectional shape of the illumination light beam. The light shielding member is arranged in a position optically approximately conjugate with resect to the electro-optic modulator.

In accordance with such a construction, the sectional shape of the illumination light beam irradiated to the image forming area of the electro-optic modulator can be correctly shaped by the function of the above light shielding member.

In the exemplary projector of the invention, it is preferable that the rotating prism is arranged in a position optically approximately conjugate with respect to the electro-optic modulator.

In accordance with such a construction, it is also possible to construct a projector having excellent moving picture display quality and uniform in-plane display characteristics, and raising no manufacture cost and no electric power consumption.

In the exemplary projector of the invention, plural electro-optic modulators that modulate plural color lights in accordance with image information corresponding to each color light are arranged as the electro-optic modulator. The projector further preferably has a color separating light guide optical system arranged between the rotating prism and the plural electro-optic modulators, and separating the illumination light beam from the rotating prism into plural color lights and guiding these plural color lights to the plural electro-optic modulators. The projector further preferably has a cross dichroic prism that synthesizes the respective color lights modulated by the plural electro-optic modulators.

In accordance with such a construction, a projector having excellent moving picture display quality and uniform in-plane display characteristics, and raising no manufacture cost and no electric power consumption can be set to a full color projector (e.g. of a three-panel type) excellent in image quality.

### BRIEF DESCRIPTION OF THE DRAWINGS

The exemplary embodiments will be described with reference to the accompanying drawings, wherein like numbers reference like elements, and wherein:

FIG. 1 is a view shown to explain a projector 1000 in accordance with a first exemplary embodiment;

FIG. 2 is a view showing the relation between the rotation of a rotating prism 770 and illuminating states on liquid crystal devices 400R, 400G, 400B;

FIG. 3A is a view showing an illuminating state of the illumination light beam L in a image forming area S of the liquid crystal devices 400R, 400G, 400B;

FIG. 3B is a view showing the inclination angle θ of the rotating prism 770 at the time of the illuminating state shown in FIG. 3A;

FIG. 3C is a view showing an illuminating state of the illumination light beam L in a image forming area S of the liquid crystal devices 400R, 400G, 400B;

FIG. 3D is a view showing the inclination angle θ of the rotating prism 770 at the time of the illuminating state shown in FIG. 3C;

FIG. 3E is a view showing the relation between the inclination angle θ of the rotating prism 770 and a moving speed of the illumination light beam L on the image forming area S.

FIG. 4A is a view showing the relation between the inclination angle of the rotating prism 770 and light intensity on the image forming area S in a projector in accordance with a comparison example;

FIG. 4B is a view showing a light intensity distribution of the screen SCR in the projector in accordance with the comparison example;

FIG. 4C is a view showing a relative value of the light intensity on the screen SCR in the projector in accordance with the comparison example;

FIG. 5 is a block diagram shown to explain the illuminating device driving circuit 710, a rotating state detecting sensor 750 and an image processing circuit 740 in the projector in accordance with the first exemplary embodiment;

FIG. 6A is a view showing a driving waveform when the illuminating device driving circuit 710 controls the light emitting amount of the light emitting tube 112;

FIG. 6B is a partially enlarged view of FIG. 6A;

FIG. 6C is a view showing the relation between the inclination angle of the rotating prism 770 and the light emitting amount of the light emitting tube 112;

FIG. 7A is a view showing the relation between the inclination angle of the rotating prism 770 and the light intensity on the image forming area S in the projector 1000 in accordance with the first exemplary embodiment;

FIG. 7B is a view showing a light intensity distribution of the screen SCR in the projector 1000 in accordance with the first exemplary embodiment;

FIG. 7C is a view showing a relative value of the light intensity on the screen SCR in the projector 1000 in accordance with the first exemplary embodiment;

FIG. 8A is a view showing a driving waveform when the illuminating device driving circuit controls the light emitting amount of the light emitting tube in a first modified example of the first exemplary embodiment;

FIG. 8B is a partially enlarged view of FIG. 8A;

FIG. 8C is a view showing the relation between the inclination angle of the rotating prism and the light emitting amount of the light emitting tube in the first modified example of the first exemplary embodiment;

FIG. 9A is a view showing a driving waveform when the illuminating device driving circuit controls the light emitting amount of the light emitting tube in a second modified example of the first exemplary embodiment;

FIG. 9B is a partially enlarged view of FIG. 9A;

FIG. 9C is a view showing the relation between the inclination angle of the rotating prism and the light emitting amount of the light emitting tube in a second modified example of the first exemplary embodiment;

FIG. 10 is a view showing a driving waveform when the illuminating device driving circuit controls the light emitting amount of the light emitting tube in a third modified example of the first exemplary embodiment;

FIG. 11 is a view showing a driving waveform when the illuminating device driving circuit controls the light emitting amount of the light emitting tube in a fourth modified example of the first exemplary embodiment;

FIG. 12 is a view showing a driving waveform when the illuminating device driving circuit controls the light emitting amount of the light emitting tube in a fifth modified example of the first exemplary embodiment;

FIG. 13 is a block diagram to explain a second exemplary embodiment;

FIG. 14 is a view showing the optical system of a projector 1004 in accordance with a third exemplary embodiment;

FIG. 15 is a view showing the optical system of a projector 1006 in accordance with a fourth exemplary embodiment;

FIG. 16 is a view showing the optical system of a projector 1008 in accordance with a fifth exemplary embodiment;

FIG. 17 is a view showing the relation between the rotation of the rotating prism 770 and the illuminating states on the liquid crystal devices 400R, 400G, 400B;

FIG. 18 is a view shown to explain a related art projector 900; and

FIG. 19 is a view showing the rotating speed of a rotating prism 960 in the related art projector 900.

### DESCRIPTION OF EXEMPLARY EMBODIMENTS

A projector according to the exemplary embodiments of the invention will be described hereinbelow with reference to the figures.

### First Exemplary Embodiment

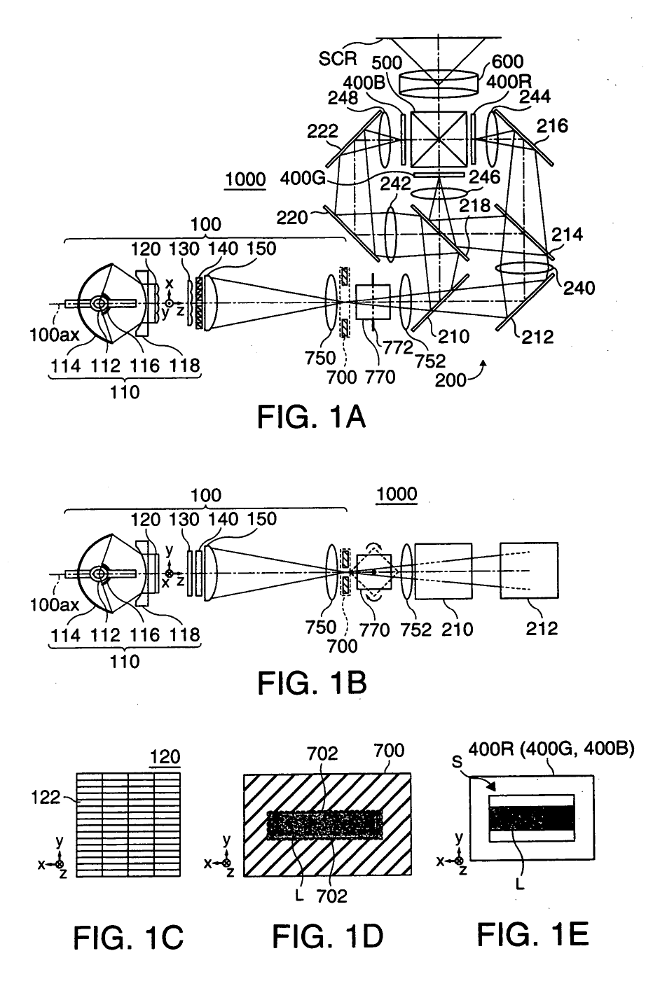

A projector 1000 in accordance with a first exemplary embodiment will first be explained by using FIG. 1.

FIG. 1 is a view shown to explain the projector 1000 in accordance with the first exemplary embodiment. FIG. 1A is a view in which an optical system of the projector 1000 is seen from the upper side. FIG. 1B is a view in which the optical system of the projector 1000 is seen from the lateral side. FIG. 1C is a front view of a first lens array 120. FIG. 1D is a view showing an illuminating state on a light shielding member 700. FIG. 1E is a view showing the illuminating state on a liquid crystal device 400R.

In the following explanation, three directions perpendicular to each other are respectively set to the z-axis direction (the direction of an illuminating optical axis 100ax in FIG. 1A), the x-axis direction (the direction parallel to a paper face in FIG. 1A and perpendicular to the z-axis), and the y-axis direction (the direction perpendicular to the paper face in FIG. 1A and perpendicular to the z-axis).

As shown in FIGS. 1A and 1B, the projector 1000 in accordance with the first exemplary embodiment has an illuminating device 100, and a color separating light guide optical system 200 that separates an illumination light beam from the illuminating device 100 into three color lights of red light, green light and blue light, and guides the color lights to an illuminated area. The projector 1000 also has three liquid crystal devices 400R, 400G, 400B as an electro-optic modulator that respectively modulate the three color lights separated by the color separating light guide optical system 200 in accordance with image information, a cross dichroic prism 500 that synthesizes the color lights modulated by these three liquid crystal devices 400R, 400G, 400B, and a projecting optical system 600 that projects the lights synthesized by the cross dichroic prism 500 onto the projecting face of a screen SCR, etc.

The illuminating device 100 has a light source device 110 that emits an approximately parallel illumination light beam on the illuminated area side, and a first lens array 120 having plural first small lenses 122 that divides the illumination light beam emitted from the light source device 110 into plural partial light beams. The illuminating device 100 also has a second lens array 130 having plural second small lenses 132 (not shown) corresponding to the plural first small lenses 122 of the first lens array 120, a polarization converting element 140 that properly arranges the illumination light beam emitted from the light source device 110 and not properly arranged in the polarizing direction as linearly polarized light of about one kind, and a superposing lens 150 that superposes each partial light beam emitted from the polarization converting element 140 on the illuminated area (in the first exemplary embodiment, an opening 702 of a shielding member 700 described later).

The light source device 110 has an ellipsoidal reflector 114, a light emitting tube 112 having a light emitting center in the vicinity of a first focal point of the ellipsoidal reflector 114, and a parallelization lens 118 that converts convergent light reflected on the ellipsoidal reflector 114 into approximately parallel light. An auxiliary minor 116 as a reflecting means that reflects light emitted from the light emitting tube 112 to the illuminated area side toward the light emitting tube 112 is arranged in the light emitting tube 112.

The light emitting tube 112 has a tube bulb portion, and a pair of seal portions extended on both sides of the tube bulb portion.

The ellipsoidal reflector 114 has a sleeve-shaped neck shape portion inserted and fixedly attached to one seal portion of the light emitting tube 112, and a reflecting concave surface that reflects light radiated from the light emitting tube 112 toward the position of a second focal point.

The auxiliary minor 116 is a reflecting member that covers about half the tube bulb portion of the light emitting tube 112 and arranged so as to be opposed to the reflecting concave surface of the ellipsoidal reflector 114. The auxiliary mirror 116 is inserted and fixedly attached to the other seal portion of the light emitting tube 112.

Light radiated from the light emitting tube 112 toward the side (the illuminated area side) opposed to the ellipsoidal reflector 114 is reflected on the auxiliary mirror 116 toward the light emitting tube 112 by using such an auxiliary mirror 116. Further, the light reflected on the auxiliary mirror 116 is emitted to the ellipsoidal reflector 114, and then this light is reflected on the reflecting concave surface of the ellipsoidal reflector 114, and is converged in the second focal point position. Thus, the light radiated from the light emitting tube 112 toward the side (the illuminated area side) opposed to the ellipsoidal reflector 114 can be converged in the second focal point position of the ellipsoidal reflector 114 similarly to light directly radiated from the light emitting tube 112 toward the ellipsoidal reflector 114.

The parallelization lens 118 is constructed by a concave lens and is arranged on the illuminated area side of the ellipsoidal reflector 114. The parallelization lens 118 is constructed so as to approximately parallelize light from the ellipsoidal reflector 114.

The first lens array 120 has a function as a light bean dividing optical element that divides light from the parallelization lens 118 into plural partial light beams. The first lens array 120 has a construction having plural first small lenses 122 arranged in a matrix within a plane perpendicular to the illuminating optical axis 100ax. As shown in FIG. 1C, the first small lenses 122 are arranged in 4 columns in the transversal direction and 16 rows in the longitudinal direction, and have a planar shape of “a rectangular shape of the longitudinal size along the y-axis direction: the transversal size along the x-axis direction=1:4”.

Namely, the first small lens 122 in the first lens array 120 has a planar shape constructed by “the rectangular shape of the longitudinal size along the y-axis direction: the transversal size along the x-axis direction=1:4” compressed in the longitudinal direction so as to set the illumination light beam (see FIG. 1E) having a sectional shape formed such that the illumination light beam emitted from the illuminating device 100 illuminates the entire image forming area S with respect to the transversal direction along the x-axis direction, and also illuminates about 50% of this image forming area S with respect to the longitudinal direction along the y-axis direction among the longitudinal and transversal directions in the image forming area S of the liquid crystal devices 400R, 400G, 400B.

The second lens array 130 is an optical element that collects plural partial light beams divided by the above first lens array 120. Similar to the first lens array 120, the second lens array 130 has a construction having plural second small lenses 132 arranged in a matrix within a plane perpendicular to the illuminating optical axis 100ax. The second small lens 132 has a planar shape compressed in the longitudinal direction (y-axis direction) and similar to the planar shape of the first small lens 122.

The polarization converting element 140 is a polarization converting element that emits light as linearly polarized light of about one kind properly arranged in the polarizing direction of each partial light beam divided by the first lens array 120.

The superposing lens 150 is an optical element that collects plural partial light beams via the first lens array 120, the second lens array 130 and the polarization converting element 140, and superposes these plural partial light beams on the opening 702 of a shielding member 700 described later.

The illumination light beam L having a sectional shape compressed in the longitudinal direction (y-axis direction) so as to illuminate the entire image forming area S with respect to the transversal direction (x-axis direction) and illuminate one portion of the image forming area S with respect to the longitudinal direction (y-axis direction) in the image forming area S of the liquid crystal devices 400R, 400G, 400B is emitted by the illuminating device 100 constructed as above (see FIG. 1D).

A light shielding member 700 that shapes the sectional shape of the illumination light beam is arranged in a position optically approximately conjugate with respect to each first small lens 122 and the liquid crystal devices 400R, 400G, 400B between the illuminating device 100 and the color separating light guide optical system 200. As shown in FIG. 1D, the light shielding member 700 has an opening 702 having a planar shape of “the rectangular shape of the longitudinal size along the y-axis direction: the transversal size along the x-axis direction=1:4”.

Thus, the sectional shape of the illumination light beam L superposed on the opening 702 of the shielding member 700 through the first lens array 120, the second lens array 130, the polarization converting element 140 and the superposing lens 150 can be correctly shaped in the sectional shape of the illumination light beam L illuminated to the image forming area S of the liquid crystal devices 400R, 400G, 400B.

The light beam emitted from the illuminating device 100 and shaped by the shielding member 700 is incident to a rotating prism 770. The rotating prism 770 is arranged between the illuminating device 100 and the liquid crystal devices 400R, 400G, 400B. The rotating prism 770 has a function that scans the illumination light beam along the longitudinal direction (y-axis direction) on the image forming area S in synchronization with a frame rate of the liquid crystal devices 400R, 400G, 400B. Field lenses 750, 752 arranged before and after the rotating prism 770 are arranged to make light effectively incident to relay lenses 240, 242 described later. The rotating prism 770 will be described later in detail.

As shown in FIG. 1A, the color separating light guide optical system 200 has dichroic mirrors 210, 214, reflecting mirrors 212, 216, 218, 220, 222, and relay lenses 240, 242. The color separating light guide optical system 200 has a function that separates the illumination light beam emitted from the rotating prism 770 into three color lights constructed by red light, green light and blue light, and guides the respective color lights to the liquid crystal devices 400R, 400G, 400B as illumination objects. An equal optical path length optical system having optical paths from the illuminating device 100 to each liquid crystal devices 400R, 400G, 400B whose optical path lengths are equal is used as the color separating light guide optical system 200. The images of light shaped by the opening 702 of the shielding member 700 are formed on the image forming areas S of the liquid crystal devices 400R, 400G, 400B by the color separating light guide optical system 200.

The dichroic mirror 210 transmits a red light component and a green light component among the light emitted from the rotating prism 770, and reflects a blue light component. The blue light component reflected on the dichroic mirror 210 is reflected on the reflecting mirror 218, and is also reflected on reflecting mirrors 220, 222 via the relay lens 242. Thereafter, the blue light component passes through a field lens 248, and reaches the liquid crystal device 400B for blue light. On the other hand, the red light component and the green light component transmitted through the dichroic mirror 210 are reflected on the reflecting mirror 212, and pass through the relay lens 240. Here, the red light component among the red light component and the green light component emitted from the relay lens 240 is transmitted through the dichroic mirror 214, and is further reflected on the reflecting mirror 216, and passes through a field lens 244 and reaches the liquid crystal device 400R for red light. The green light component reflected on the dichroic mirror 214 is further reflected on the reflecting minor 218, and passes through a field lens 246 and reaches the liquid crystal device 400G for green light. The field lenses 244, 246, 248 arranged at the former stage of the optical path of each color light of the liquid crystal devices 400R, 400G, 400B are arranged to convert each partial light beam emitted from the second lens array 130 into a light beam approximately parallel with respect to each principal ray.

The liquid crystal devices 400R, 400G, 400B modulate the illumination light beam in accordance with image information, and become an illumination object of the illuminating device 100. Unillustrated incident side polarizing plates are respectively interposed and arranged between the field lenses 244, 246, 248 and each of the liquid crystal devices 400R, 400G, 400B. Unillustrated emitting side polarizing plates are respectively interposed and arranged between each of the liquid crystal devices 400R, 400G, 400B and the cross dichroic prism 500. Each incident color light is optically modulated by these incident side polarizing plates, the liquid crystal devices 400R, 400G, 400B and the emitting side polarizing plates.

In the liquid crystal devices 400R, 400G, 400B, a liquid crystal as an electro-optic substance is sealed and closed in a pair of transparent glass substrates. For example, the liquid crystal devices 400R, 400G, 400B modulate the polarizing direction of linearly polarized light of one kind emitted from the incident side polarizing plate in accordance with a given image signal with polysilicon TFT as a switching element.

A liquid crystal device for wide vision having a planar shape of “the rectangular shape of the longitudinal size along the y-axis direction: the transversal size along the x-axis direction=9:16” is used as the liquid crystal devices 400R, 400G, 400B.

The cross dichroic prism 500 is an optical element that forms a color image by synthesizing an optical image modulated every each color light emitted from the emitting side polarizing plate. This cross dichroic prism 500 is approximately formed in a square shape seen from a plane and constructed by bonding four rectangular prisms. Dielectric multilayer films are formed at the interface of an approximately X-character shape in which the rectangular prisms are stuck to each other. The dielectric multilayer film formed at one interface of the approximately X-character shape reflects the red light. The dielectric multilayer film formed at the other interface reflects the blue light. The red light and the blue light are refracted by these dielectric multilayer films, and are properly arranged in an advancing direction of the green light so that the three color lights are synthesized.

The color image emitted from the cross dichroic prism 500 is enlarged and projected by the projecting optical system 600 so that a large screen image is formed on the screen SCR.

The rotating prism 770 and the illuminating device driving circuit 710 in the projector 1000 in accordance with the first exemplary embodiment will next be explained in detail.

Rotating Prism

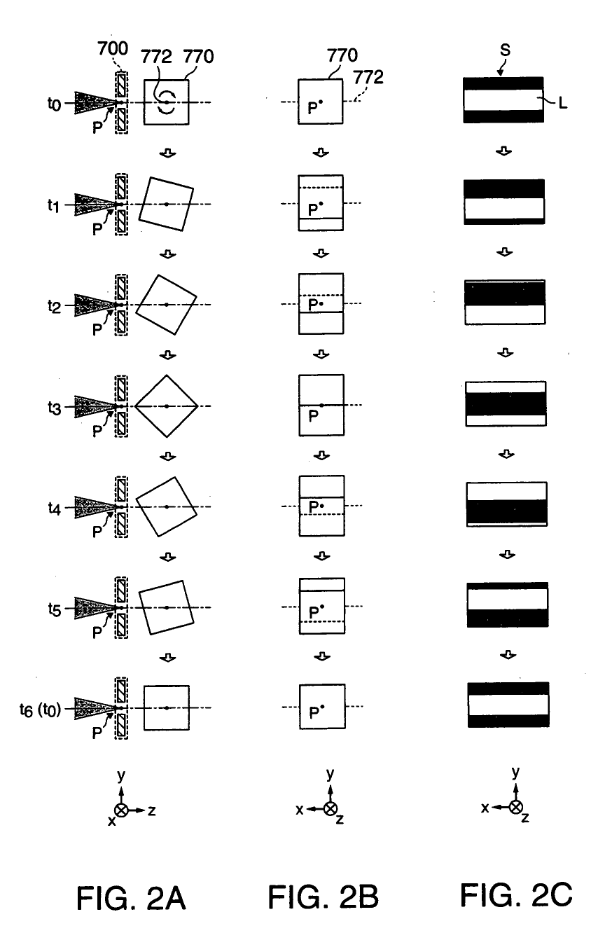

FIG. 2 is a view showing the relation between the rotation of the rotating prism 770 and an illuminating state on the liquid crystal devices 400R, 400G, 400B. FIG. 2A is a cross-sectional view when the rotating prism 770 is seen along the rotating axis 772. FIG. 2B is a view when the rotating prism 770 is seen along the illuminating optical axis 100ax. FIG. 2C is a view showing the illuminating state of the illumination light beam L on the image forming area S of the liquid crystal devices 400R, 400G, 400B.

The rotating prism 770 is constructed so as to be rotated in synchronization with a frame rate of the liquid crystal devices 400R, 400G, 400B. Therefore, as shown in FIGS. 2A to 2C, when the rotating prism 770 is rotated, predetermined refraction is performed by a light transmissive surface of the rotating prism 770 with respect to light emitted from an image P of a virtual central point of the first small lens 122 on the illuminating optical axis 100ax. As a result, in the image forming area S of the liquid crystal devices 400R, 400G, 400B, a light illuminating area and a light non-illuminating area are sequentially scrolled in synchronization with the frame rate.

Therefore, in accordance with the projector 1000 in the first exemplary embodiment, the illumination light beam L is scanned on the image forming area S of the liquid crystal devices 400R, 400G, 400B by rotating the rotating prism 770. As a result, light is intermittently interrupted if an arbitrary point in the image forming area S of the liquid crystal devices 400R, 400G, 400B is noticed. Therefore, moving picture display quality are improved, and excellent moving picture display quality are provided.

Illuminating Device Driving Circuit

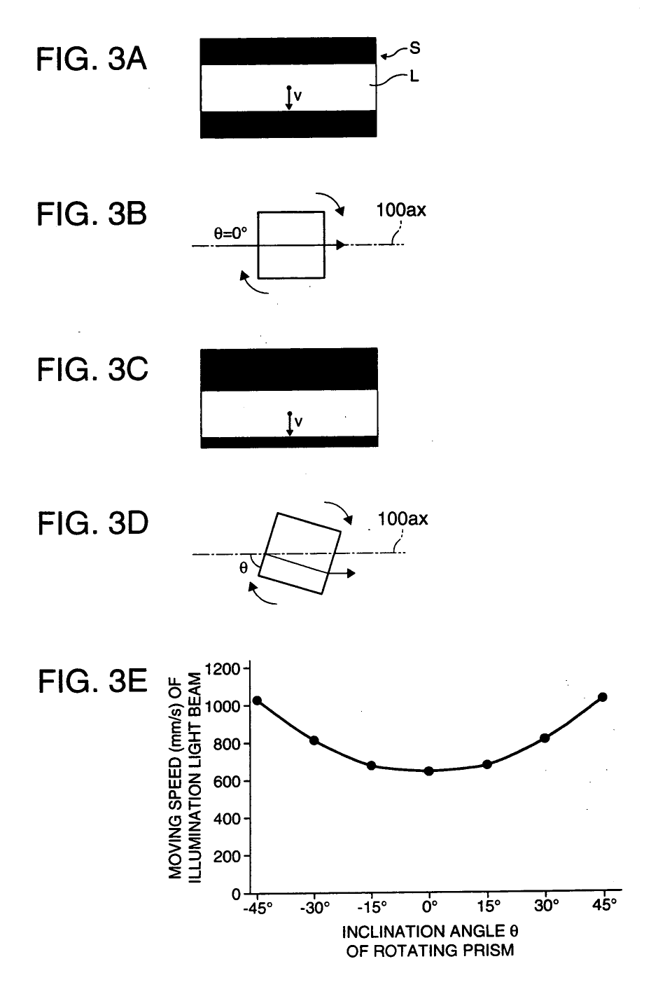

FIGS. 3 to 7 are views shown to explain an effect of the illuminating device driving circuit 710.

FIGS. 3A to 3D are views showing the illuminating state of the illumination light beam L in the image forming area S of the liquid crystal devices 400R, 400G, 400B, and an inclination angle θ of the rotating prism 770. FIG. 3E is a view showing the relation of the inclination angle θ of the rotating prism 770 and a moving speed of the illumination light beam L on the image forming area S. Each of arrows v shown within FIGS. 3A and 3C shows the moving speed at a virtual central point of the illumination light beam L by a vector. FIG. 3B shows the inclination angle θ of the rotating prism 770 at the time of the illuminating state (a state in which the illumination light beam L is illuminating a longitudinal central portion of the image forming area S) shown in FIG. 3A. FIG. 3D shows the inclination angle θ of the rotating prism 770 at the time of the illuminating state (a state in which the illumination light beam L is illuminating both longitudinal end portions of the image forming area S) shown in FIG. 3C. In FIG. 3E, the inclination angle θ of the rotating prism 770 when the illuminating optical axis 100ax is perpendicularly incident to a rotating prism face is set to “inclination angle θ=0°” (hereinafter, the same contents are set in this specification).

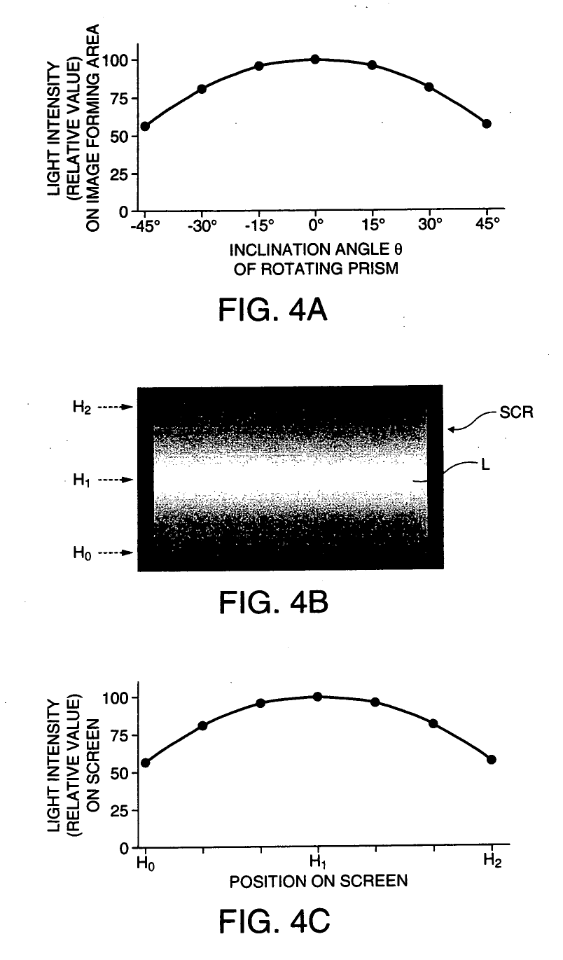

FIG. 4A is a view showing the relation between the inclination angle of the rotating prism 770 and light intensity on the image forming area S in a projector in accordance with a comparison example using no illuminating device driving circuit. FIG. 4B is a view showing a light intensity distribution of the screen SCR in the projector in accordance with the comparison example. FIG. 4C is a view showing a relative value of the light intensity on the screen SCR in the projector in accordance with the comparison example.

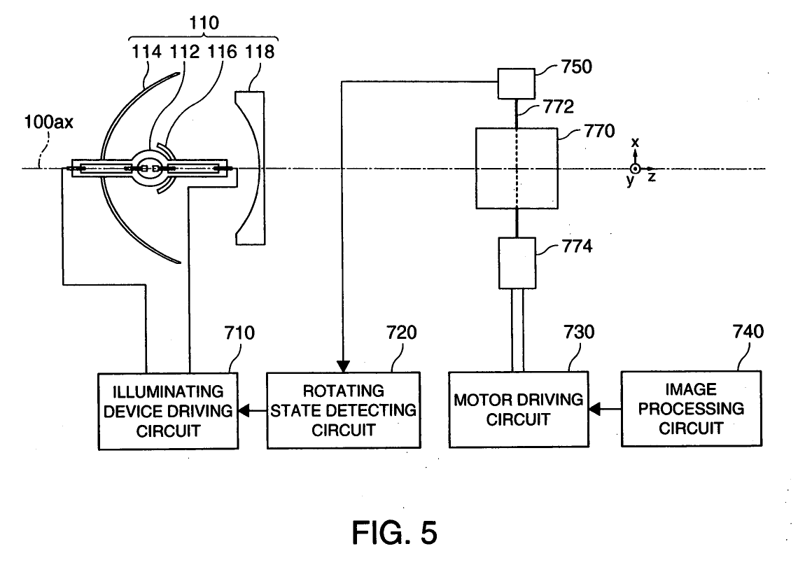

FIG. 5 is a block diagram shown to explain the illuminating device driving circuit 710, a rotating state detecting sensor 750 and an image processing circuit 740 in the projector in accordance with the first exemplary embodiment. In FIG. 5, optical elements arranged from the parallelization lens 118 to the rotating prism 770 and optical elements arranged at the latter stage of the optical path from the rotating prism 770 are omitted in illustration.

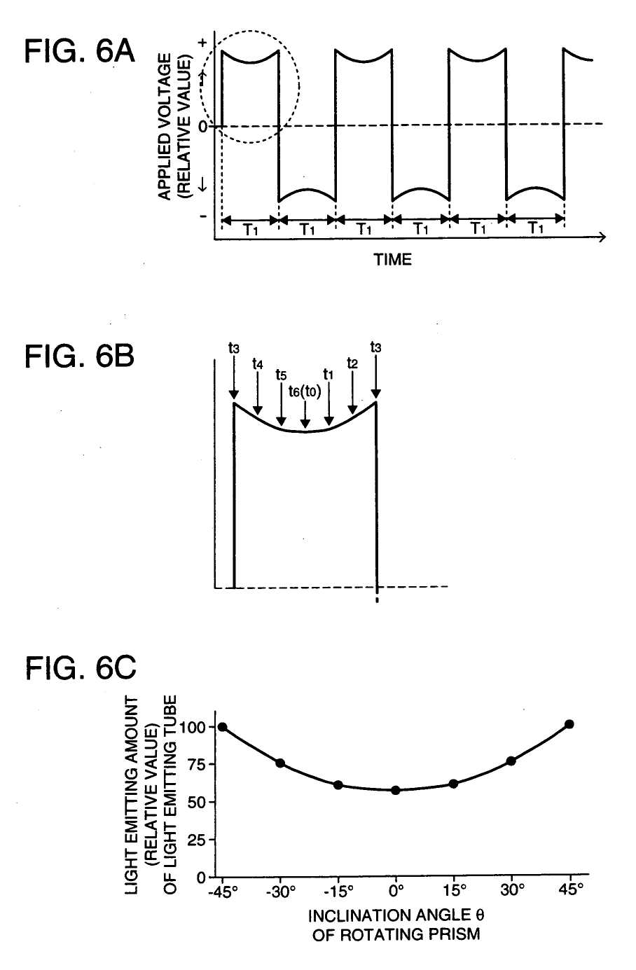

FIG. 6A is a view showing a driving waveform when the illuminating device driving circuit 710 controls the light emitting amount of the light emitting tube 112. FIG. 6B is a partially enlarged view of FIG. 6A. FIG. 6C is a view showing the relation between the inclination angle of the rotating prism 770 and the light emitting amount of the light emitting tube 112. Reference numerals t₀ to t₆ within FIG. 6B correspond to reference numerals t₀ to t₆ within FIG. 2A

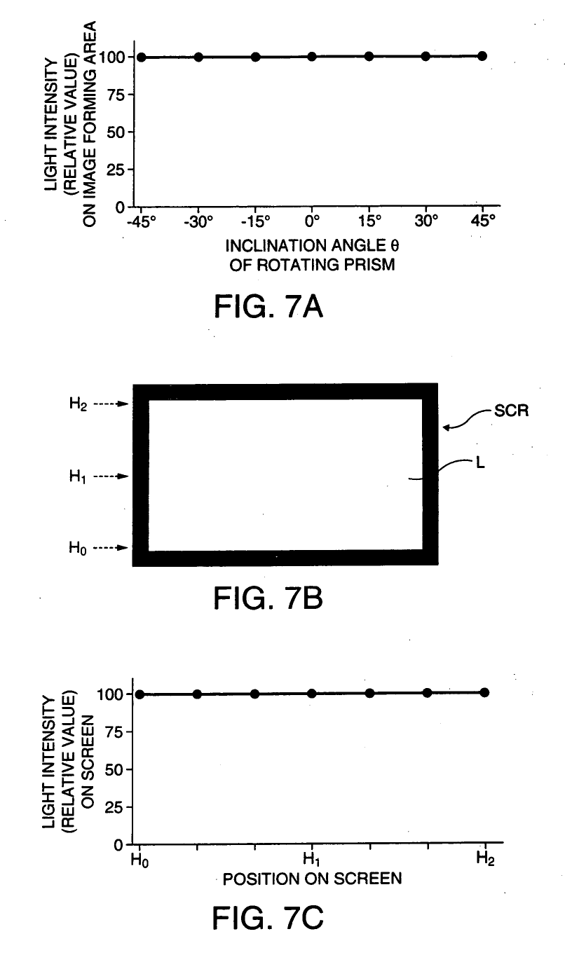

FIG. 7A is a view showing the relation between the inclination angle of the rotating prism 770 and the light intensity on the image forming area S in the projector 1000 in accordance with the first exemplary embodiment FIG. 7B is a view showing a light intensity distribution of the screen SCR in the projector 1000 in accordance with the first exemplary embodiment FIG. 7C is a view showing a relative value of the light intensity on the screen SCR in the projector 1000 in accordance with the first exemplary embodiment. FIGS. 7A to 7C show a relative value of the light intensity at each inclination angle θ with respect to the light intensity at the time of inclination angle θ=0°, in the case where the light intensity at the time of inclination angle θ=0° is set to 100.

In the construction for scanning the illumination light beam L on the image forming area S of the liquid crystal devices 400R, 400G, 400B by rotating the rotating prism 770 at a constant speed, the moving speed (scanning speed) of the illumination light beam L is changed in accordance with its position on the image forming area S of the liquid crystal device. Namely, as shown in FIG. 3, the moving speed of the illumination light beam in both longitudinal end portions of the image forming area S becomes faster than the moving speed of the illumination light beam in the longitudinal central portion of the image forming area S. Therefore, in the unillustrated projector in accordance with the comparison example using no illuminating device driving circuit, as shown in FIG. 4A, illuminance in both the longitudinal (y-axis direction) end portions of the image forming area S in the liquid crystal devices 400R, 400G, 400B is lower than that in the longitudinal central portion. Therefore, as shown in FIGS. 4B and 4C, illuminance in both the longitudinal end portions (reference numerals H₀, H₂) of the screen SCR is similarly lower than that in the longitudinal (y-axis direction) central portion (reference numeral H₁) on the screen SCR.

In contrast to this, as shown in FIG. 5, the illuminating device driving circuit 710 is further arranged in the projector 1000 in accordance with the first exemplary embodiment. As can be seen from FIGS. 4A and 6, this illuminating device driving circuit 710 has a function that controls the light emitting amount of the light emitting tube 112 so as to reduce the light amount of the illumination light beam emitted from the light source device 110 when the illumination light beam L passes through the longitudinal (y-axis direction) central portion in the image forming area S of the liquid crystal devices 400R, 400G, 400B. The illuminating device driving circuit 710 also has a function that controls the light emitting amount of the light emitting tube 112 so as to increase the light amount of the illumination light beam emitted from the light source device 110 when the illumination light beam L passes through both the longitudinal (y-axis direction) end portions in the image forming area S of the liquid crystal devices 400R, 400G, 400B. Namely, the illuminating device driving circuit 710 has a function that controls the light amount of the illumination light beam emitted from the illumining device 100 in time so as to reduce an illuminance difference generated by changing the moving speed (scanning speed) of the illumination light beam L on the image forming area S in the liquid crystal devices 400R, 400G, 400B.

Therefore, in accordance with the projector 1000 in the first exemplary embodiment, as shown in FIG. 7A, the above illuminance difference generated when the rotating prism 770 is rotated at a constant rotating speed is reduced. As shown in FIGS. 7B and 7C, more uniform display can be performed on the entire screen SCR. Namely, uniform in-plain display characteristics are provided.

Thus, in accordance with the projector 1000 in the first exemplary embodiment, it is not necessary to change the rotating speed of the rotating prism in a very short period. Therefore, it is not necessary to use an expensive motor as a motor for operating the rotating prism. It is also not necessary to frequently accelerate and decelerate the rotating speed of the motor for operating the rotating prism. Therefore, there is no case in which manufacture cost is raised and electric power consumption is raised.

Therefore, the projector 1000 in accordance with the first exemplary embodiment becomes a projector having excellent moving picture display quality and uniform in-plane display characteristics and raising no manufacture cost and no electric power consumption.

As shown in FIG. 5, the projector 1000 in accordance with the first exemplary embodiment father has the rotating state detecting sensor 750 that detects the rotating state of the rotating prism 770, and the rotating state detecting circuit 720 that processes an output signal of the rotating state detecting sensor 750 and outputs this output signal to the illuminating device driving circuit 710. The illuminating device driving circuit 710 is constructed so as to control the light amount of the illumination light beam emitted from the illuminating device 100 on the basis of an output signal of the rotating state detecting circuit 720.

Therefore, in accordance with the projector 1000 in the first exemplary embodiment, accurate control corresponding to the rotating state of the rotating prism 770 can be performed. Accordingly, it is possible to effectively reduce the illuminance difference generated by changing the moving speed (scanning speed) of the illumination light beam on the image forming area S in the liquid crystal devices 400R, 400G, 400B.

The projector 1000 in accordance with the first exemplary embodiment is constructed so as to rotate the rotating prism 770 in synchronization with the frame rate of the liquid crystal devices 400R, 400G, 400B by driving the motor 774 by the motor driving circuit 730 on the basis of an output signal from the image processing circuit 740 that processes image information.

In the projector 1000 in accordance with the first exemplary embodiment, the illuminating device driving circuit 710 is constructed so as to control the light emitting amount of the light emitting tube 112. Therefore, the light amount of the illumination light beam emitted from the illuminating device 100 can be effectively controlled.

The rotating prism 770 and the illuminating device driving circuit 710 in the projector 1000 in accordance with the first exemplary embodiment have been explained in detail, but the projector 1000 in accordance with the first exemplary embodiment also has the following features.

In the projector 1000 in accordance with the first exemplary embodiment, the light source device 110 is a light source device having the light emitting tube 112, the ellipsoidal reflector 114 that reflects light from the light emitting tube 112, and the parallelization lens 118 that converts light reflected on the ellipsoidal reflector 114 to approximately parallel light

Therefore, in accordance with the projector 1000 in the first exemplary embodiment, a compacter light source device can be realized in comparison with the light source device using a parabolic reflector.

In the projector 1000 in accordance with the first exemplary embodiment, the auxiliary mirror 116 that reflects light emitted from the light emitting tube 112 to the illuminated area side toward the light emitting tube 112 is arranged in the light emitting tube 112.

Therefore, in accordance with the projector 1000 in the first exemplary embodiment, the light radiated from the light emitting tube 112 to the illuminated area side is reflected toward the light emitting tube 112. Therefore, it is not necessary to set the size of the ellipsoidal reflector 114 to a size for covering an illuminated area side end portion of the light emitting tube 112. Accordingly, the ellipsoidal reflector 114 can be made compact so that the projector 1000 can be made compact. This also means that the size of the first lens array 120, the size of the second lens array 130, the size of the polarization converting element 140, the size of the superposing lens 150, the size of the color separating optical system 200, etc. can be further reduced. Thus, the projector 1000 can be made further compact.

In the projector 1000 in accordance with the first exemplary embodiment, the three liquid crystal devices 400R, 400G, 400B that modulate the three color lights emitted from the color separating light guide optical system 200 in accordance with image information corresponding to each color light are arranged as an electro-optic modulator. Further, the projector 1000 has the color separating light guide optical system 200 arranged between the rotating prism 770 and the liquid crystal devices 400R, 400G, 400B and separating the illumination light beam from the rotating prism 770 into the three color lights and guiding the three color lights to the liquid crystal devices 400R, 400G, 400B. The projector 1000 further has the cross dichroic prism 500 that synthesizes the respective color lights modulated in the liquid crystal devices 400R, 400G, 400B.

Therefore, in accordance with the projector 1000 in the first exemplary embodiment, a projector having light utilization efficiency not greatly reduced even when smooth moving picture display of good quality is obtained can be set to a full color projector of a three-panel type excellent in image quality.

The projector 1000 in accordance with the first exemplary embodiment further has the polarization converting element 140 that properly arranges and emits the illumination light beam from the light source device 110 as the linearly polarized light of one kind. The polarization converting element 140 has a polarization separating layer that transmits one linearly polarized light component among polarized components included in the illumination light beam from the light source device 110 as it is, and reflects the other linearly polarized light component in the direction perpendicular to the illuminating optical axis 100ax. The polarization converting element 140 also has a reflecting layer that reflects the other linearly polarized light component reflected on the polarization separating layer in the direction parallel to the illuminating optical axis 100ax. The polarization converting element 140 further has a phase plate that performs polarization conversion so as to properly arrange light as a linearly polarized light component that is any one of the one linearly polarized light component transmitted through the polarization separating layer and the other linearly polarized light component reflected on the reflecting layer.

Therefore, the illumination light beam from the light source device 110 can be converted into the linearly polarized light of one kind having one polarization axis by the action of the polarization converting element 140. Therefore, the illumination light beam from the light source device 110 can be effectively utilized when the electro-optic modulator of a type utilizing the linearly polarized light of one kind is used as in the liquid crystal device, etc. as the elect optic modulator as in the projector 1000 in accordance with the first exemplary embodiment

In the projector 1000 in accordance with the first exemplary embodiment, a reflection reducing film is formed on the light transmitting surface of the rotating prism 770. Therefore, since light transmittance in the rotating prism 770 is improved, a reduction in light utilization efficiency can be minimized, and a stray light level is reduced and contrast is improved.

In the projector 1000 in accordance with the first exemplary embodiment, the explanation is made by illustrating the construction in which the illuminating device driving circuit 710 controls the light emitting amount of the light emitting tube 112 by a driving waveform as shown in FIG. 6A. However, the invention is not limited to this construction. For example, there are also the following modified examples.

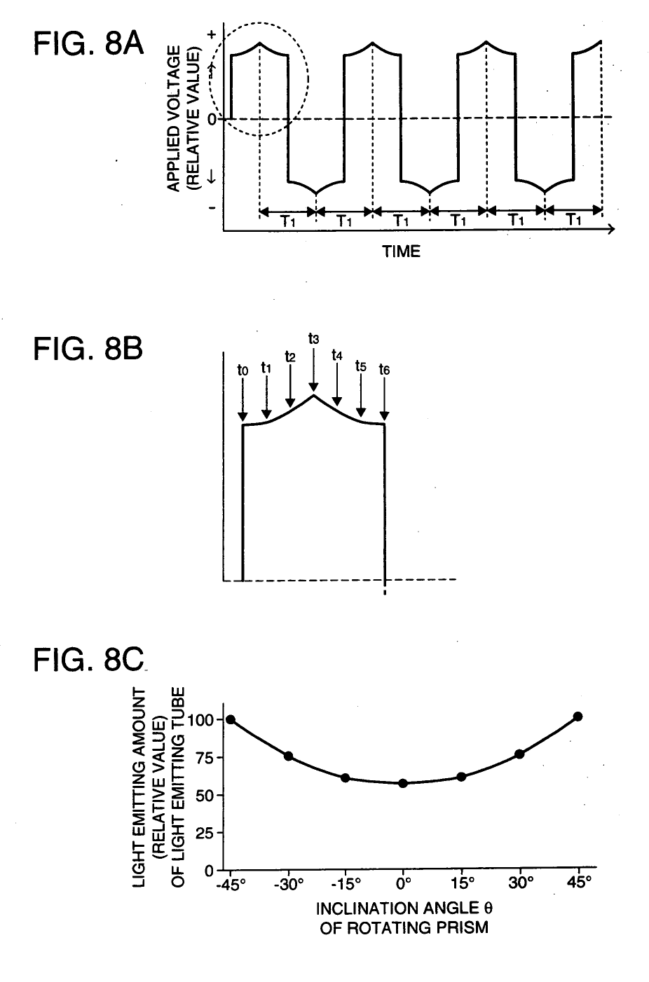

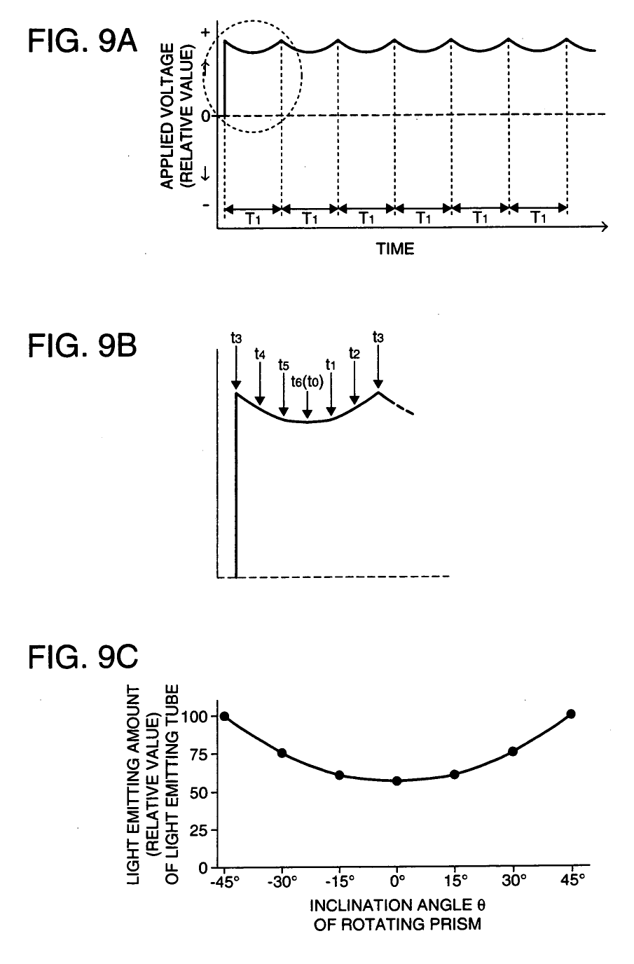

FIGS. 8 to 12 are views shown to explain the function of the illuminating device driving circuit in projectors in accordance with first to fifth modified examples of the first exemplary embodiment. FIG. 8A is a view showing a driving waveform when the illuminating device driving circuit in first modified example controls the light emitting amount of the light emitting tube. FIG. 8B is a partially enlarged view of FIG. 8A. FIG. 8C is a view showing the relation between the inclination angle of the rotating prism and the light emitting amount of the light emitting tube. FIG. 9A is a view showing a driving waveform when the illuminating device driving circuit in second modified example controls the light emitting amount of the light emitting tube. FIG. 9B is a partially enlarged view of FIG. 9A. FIG. 9C is a view showing the relation between the inclination angle of the rotating prism and the light emitting amount of the light emitting tube.

As shown in FIGS. 8A and 8B, the driving waveform in controlling the light emitting amount of the light emitting tube by the illuminating device driving circuit in the projector in accordance with first modified example is different in timing for inverting polarities in comparison with the driving waveform in controlling the light emitting amount of the light emitting tube 112 by the illuminating device driving circuit 710 in the projector 1000 in accordance with the first exemplary embodiment

As shown in FIGS. 9A and 9B, the driving waveform in controlling the light emitting amount of the light emitting tube by the illuminating device driving circuit in the projector in accordance with second modified example is different in direct current driving in comparison with the driving waveform in controlling the light emitting amount of the light emitting tube 112 by the illuminating device driving circuit 710 in the projector 1000 in accordance with the first exemplary embodiment

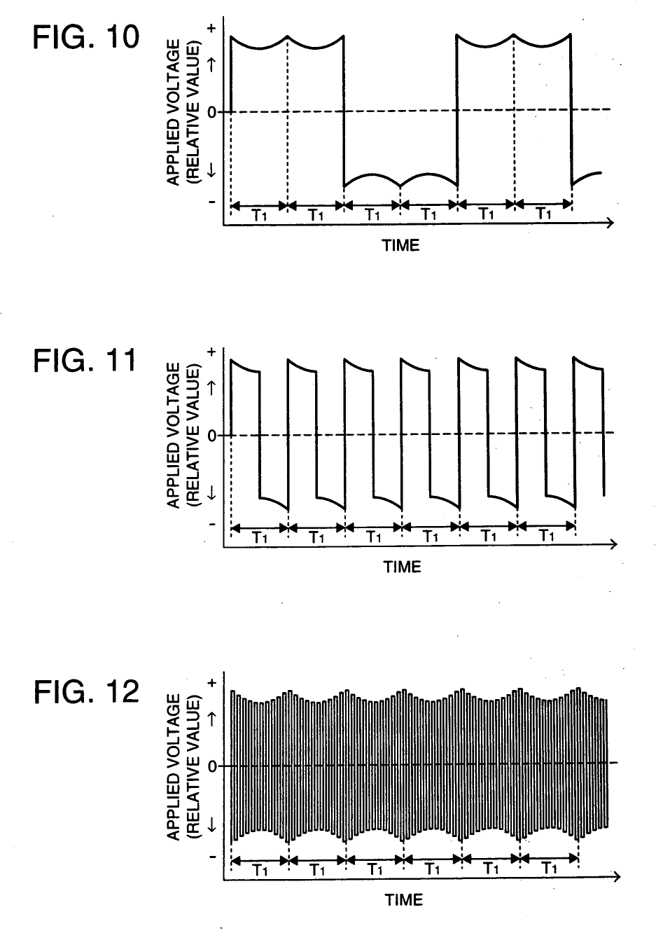

As shown in FIG. 10, the driving waveform in controlling the light emitting amount of the light emitting tube by the illuminating device driving circuit in the projector in accordance with third modified example differs from the driving waveform in controlling the light emitting amount of the light emitting tube 112 by the illuminating device driving circuit 710 in the projector 1000 in accordance with the first exemplary embodiment in that a period for inverting polarities is long.

As shown in FIG. 11, the driving waveform in controlling the light emitting amount of the light emitting tube by the illuminating device driving circuit in the projector in accordance with fourth modified example differs from the driving waveform in controlling the light emitting amount of the light emitting tube by the illuminating device driving circuit in the projector in accordance with the first exemplary embodiment in that the period for inverting polarities is short.

As shown in FIG. 12, the driving waveform in controlling the light emitting amount of the light emitting tube by the illuminating device driving circuit in the projector in accordance with fifth modified example differs from the driving waveform in controlling the light emitting amount of the light emitting tube 112 by the illuminating device driving circuit 710 in the projector 1000 in accordance with the first exemplary embodiment in that the period for inverting polarities is further short

Thus, the projectors in accordance with first to fifth modified examples differ from the projector 1000 in accordance with the first exemplary embodiment in the driving waveform in controlling the light emitting amount of the light emitting tube by the illuminating device driving circuit. However, similar to the case of the projector 1000 in accordance with the first exemplary embodiment, the projector has the illuminating device driving circuit having a function that controls the light amount of the illumination light beam emitted from the unillustrated illuminating device 100 in time so as to reduce the illuminance difference generated by changing the moving speed (scanning speed) of the illumination light beam L on the image forming area in the unillustrated liquid crystal devices 400R, 400G, 400B. Therefore, in the projectors in accordance with first to fifth modified examples, similar to the case of the projector 1000 in accordance with the first exemplary embodiment, the above illuminance difference generated when the rotating prism is rotated at a constant rotating speed is reduced, and more uniform display can be performed on the entire screen face. Namely, uniform in-plane display characteristics are provided.

### Second Exemplary Embodiment

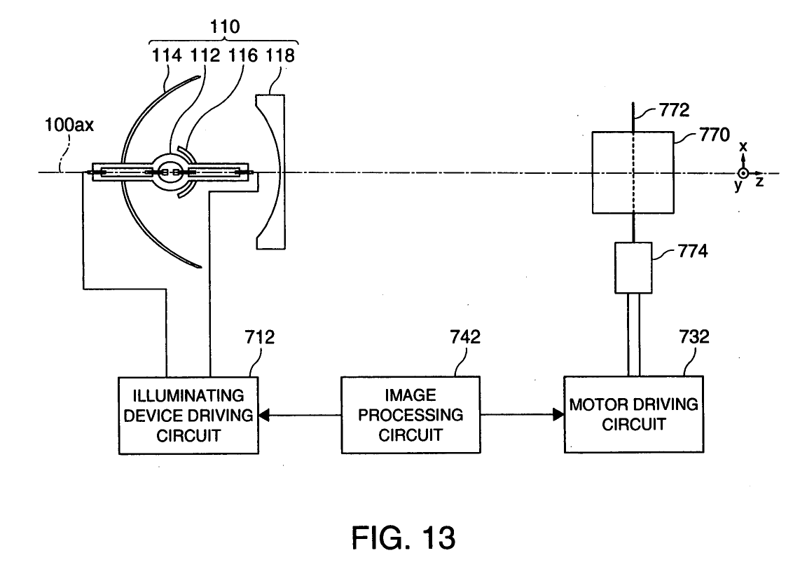

FIG. 13 is a view shown to explain a projector 1002 in accordance with a second exemplary embodiment. In FIG. 13, the same reference numerals as FIG. 5 are designated with respect to the same members as FIG. 5, and their detailed explanations are omitted.

The projector 1002 in accordance with the second exemplary embodiment basically has a construction similar to that of the projector 1000 in accordance with the first exemplary embodiment. However, as shown in FIG. 13, the projector 1002 differs from the projector 1000 in accordance with the first exemplary embodiment in a control means of the illuminating device driving circuit

Namely, in the projector 1000 in accordance with the first exemplary embodiment, the rotating state detecting sensor 750 (see FIG. 5) that detects the rotating state of the rotating prism 770 is used as the above control means. The illuminating device driving circuit 710 is constructed so as to control the light amount of the illumination light beam emitted from the light source device 110 on the basis of an output signal of the rotating state detecting sensor 750.

In contrast to this, in the projector 1002 in accordance with the second exemplary embodiment, an image processing circuit 742 that processes image information is used instead of the rotating state detecting sensor as the above means as shown in FIG. 13. The rotating prism 770 is constructed so as to be rotated at a constant speed on the basis of a synchronous signal from the image processing circuit 742. An illuminating device driving circuit 712 is constructed so as to control the light amount of the illumination light beam emitted from the light source device 110 on the basis of the synchronous signal from the image processing circuit 742.

In the projector 1002 in accordance with the second exemplary embodiment, both of the rotation of the rotating prism 770 and the control of the light amount of the illumination light beam emitted from the light source device 110 activate based on the synchronous signal from the image processing circuit 742. Therefore, it is also possible to perform accurate control the light amount of the illumination light beam emitted from the light source device 110 corresponding to the rotating state of the rotating prism 770 by the above construction. Therefore, it is possible to effectively reduce the illuminance difference generated by changing the scanning speed of the illumination light beam on the image forming area in the liquid crystal devices 400R, 400G, 400B.

Thus, the projector 1002 in accordance with the second exemplary embodiment differs from the projector 1000 in accordance with the first exemplary embodiment in the control means of the illuminating device driving circuit for reducing the illuminance difference generated by changing the moving speed (scanning speed) of the illumination light beam on the image forming area in the liquid crystal device. However, similar to the case of the projector 1000 in accordance with the first exemplary embodiment, the projector 1002 in accordance with the second exemplary embodiment has the illuminating device driving circuit 712 that controls the light amount of the illumination light beam emitted from the light source device 110 in time. Therefore, the illuminance difference generated when the rotating prism 770 is rotated at a constant rotating speed is reduced. Thus, more uniform display can be performed on the entire screen face. Namely, uniform in-plane display characteristics are provided

Accordingly, the projector 1002 in accordance with the second exemplary embodiment has a construction similar to that of the projector 1000 in accordance with the first exemplary embodiment except for the control means of the illuminating device driving circuit. Therefore, the projector 1002 in accordance with the second exemplary embodiment has effects similar to those of the projector 1000 in accordance with the first exemplary embodiment

### Third Exemplary Embodiment

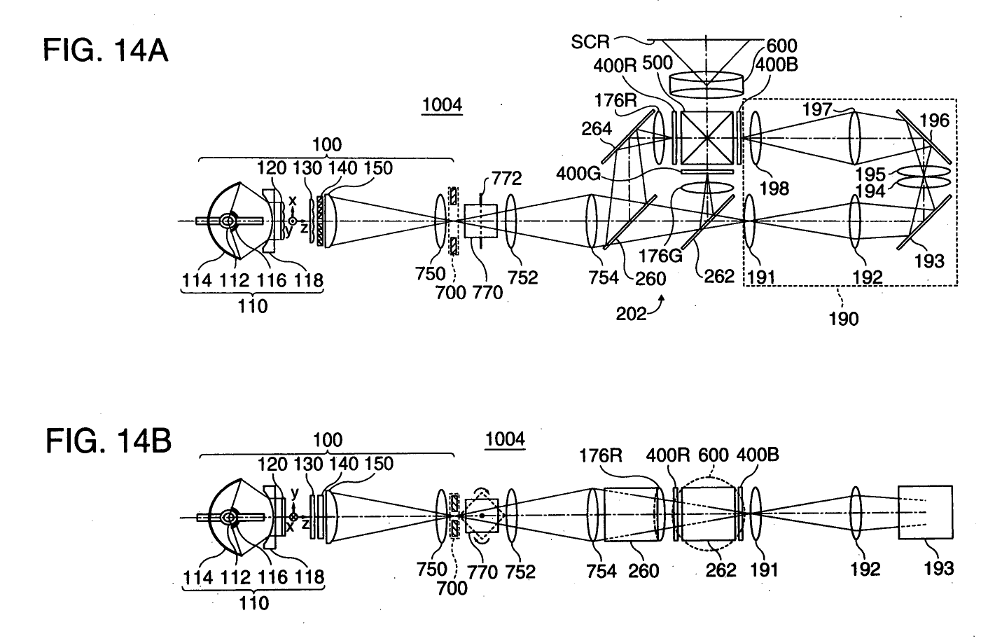

FIG. 14 is a view showing the optical system of a projector 1004 in accordance with a third exemplary embodiment. FIG. 14A is a view in which the optical system of the projector 1004 is seen from the upper side. FIG. 14B is a view in which the optical system of the projector 1004 is seen from the lateral side.

The projector 1004 in accordance with the third exemplary embodiment basically has a construction similar to that of the projector 1000 in accordance with the first exemplary embodiment. However, as shown in FIG. 14A, the projector 1004 in accordance with the third exemplary embodiment differs from the projector 1000 in accordance with the first exemplary embodiment in the construction of the color separating light guide optical system. Namely, in the projector 1004 in accordance with the third exemplary embodiment, a double relay optical system 190 is used as the color separating light guide optical system 202 so as to set all directions for scrolling the light illuminating area and the light non-illuminating area on the respective liquid crystal devices 400R, 400G, 400B to the same direction.

As shown in FIG. 14A, the color separating light guide optical system 202 has dichroic mirrors 260, 262, a reflecting mirror 264 and the double relay optical system 190. The double relay optical system 190 has relay lenses 191, 192, 194, 195, 197, reflecting mirrors 193, 196 and a field lens 198. A relay lens 754 is arranged at the former stage of an optical path of the color separating light guide optical system 202.

The dichroic mirror 260 reflects a red light component among light emitted from the rotating prism 770, and transmits a green light component and a blue light component. The red light component reflected on the dichroic mirror 260 is reflected on the reflecting mirror 264 and passes through a field lens 176R and reaches the liquid crystal device 400R for red light. The green light component among the green light component and the blue light component transmitted through the dichroic mirror 260 is reflected on the dichroic mirror 262, and passes through a field lens 176G and reaches the liquid crystal device 400G for green light. On the other hand, the blue light component transmitted through the dichroic mirror 260 is transmitted through the dichroic mirror 262 and passes through the double relay optical system 190 and reaches the liquid crystal device 400B for blue light. The field lenses 176R, 176G, 198 arranged at the former stage of the optical path of each color light of the liquid crystal devices 400R, 400G, 400B are arranged to convert each partial light beam emitted from the second lens array 130 into a light beam approximately parallel to each principal ray.

Here, the double relay optical system 190 is arranged in the optical path of the blue light to prevent a reduction in utilization efficiency of light due to dispersion of light, etc. since the length of the optical path of the blue light is longer than the lengths of the optical paths of the other color lights. The double relay optical system 190 is also arranged in the optical path of the blue light to set all the directions for scrolling the light illuminating area and the light non-illuminating area on each of the liquid crystal devices 400R, 400G, 400B to the same direction. The projector 1004 in accordance with the third exemplary embodiment is constructed by using the double relay optical system 190 in the optical path of the blue light among the three color lights, but may also be constructed by using such a double relay optical system in the optical path of another color light such as the red light, etc.

Thus, the projector 1004 in accordance with the third exemplary embodiment differs from the projector 1000 in accordance with the first exemplary embodiment in the construction of the color separating light guide optical system. However, similar to the case of the projector 1000 in accordance with the first exemplary embodiment, the projector 1004 has an unillustrated illuminating device driving circuit that controls the light amount of the illumination light beam emitted from the light source device 110 in time on the basis of the output signal of an unillustrated rotating state detecting sensor. Therefore, the illuminance difference generated when the rotating prism 770 is rotated at a constant rotating speed is reduced. Thus, more uniform display can be performed on the entire screen SCR. Namely, uniform in-plane display characteristics are provided.

As mentioned above, the projector 1004 in accordance with the third exemplary embodiment is constructed by arranging the illumining device driving circuit that controls the light amount of the illumination light beam emitted from the light source device 110 in time on the basis of the output signal of the rotating state detecting sensor. However, similar to the case of the projector 1002 in accordance with the second exemplary embodiment, the projector 1004 may also be constructed by arranging the illuminating device driving circuit that controls the light amount of the illumination light beam emitted from the light source device 110 on the basis of a synchronous signal from an image processing circuit

Accordingly, since the projector 1004 in accordance with the third exemplary embodiment has a construction similar to that of each of the projectors 1000, 1002 in accordance with the first or second exemplary embodiment except for the construction of the color separating light guide optical system, the projector 1004 has effects similar to those in the case of each of the projectors 1000, 1002 in accordance with the fist or second exemplary embodiment

### Fourth Exemplary Embodiment

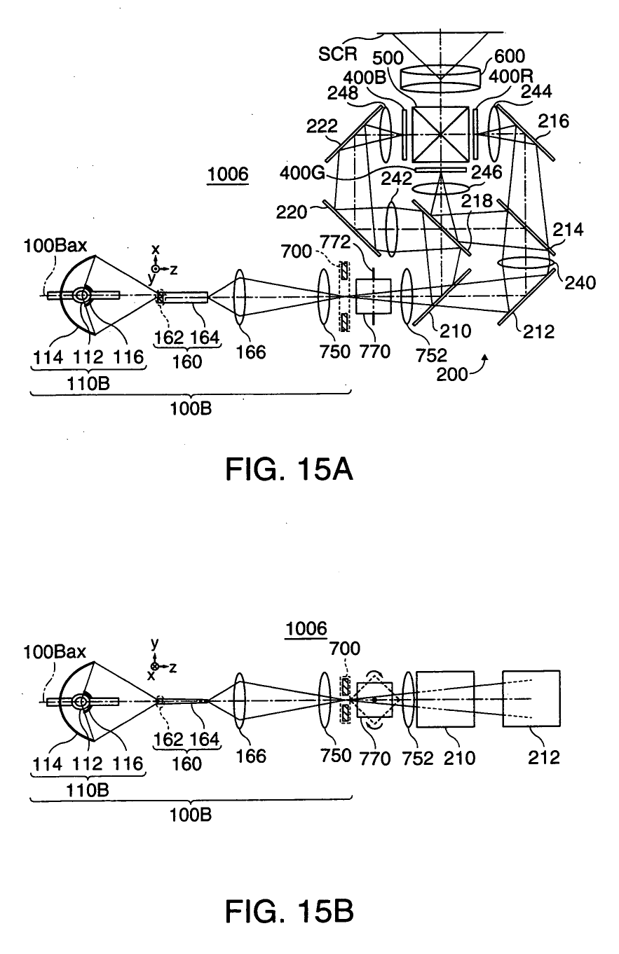

FIG. 15 is a view showing the optical system of a projector 1006 in accordance with a fourth exemplary embodiment. FIG. 15A is a view in which the optical system of the projector 1006 is seen from the upper side. FIG. 15B is a view in which the optical system of the projector 1006 is seen from the lateral side.

The projector 1006 in accordance with the fourth exemplary embodiment basically has a construction similar to that of the projector 1000 in accordance with the fist exemplary embodiment, but differs from the projector 1000 in accordance with the first exemplary embodiment in the construction of the illuminating device as shown in FIGS. 15A and 15B. Namely, a rod integrator optical system is used as an illuminating device 100B in the projector 1006 in accordance with the fourth exemplary embodiment

The illuminating device 100B has a light source device 110B that emits a convergent illumination light beam onto the illuminated area side, an integrator rod 160 that converts the illumination light beam from the light source device 110B into an illumination light beam having a more uniform intensity distribution, and a relay lens 162. A light shielding member 700 is arranged in a position optically approximately conjugate with respect to a light emitting face of the integrator rod 160 and the liquid crystal devices 400R, 400G, 400B.

The integrator rod 160 has a polarization converting section 162 that properly arranges the illumination light beam, which is not properly arranged in the polarizing direction, emitted from the light source device 110B as linearly polarized light of about one kind, and also has a rod portion 164. The polarization converting section 162 has a polarization separating layer that transmits one linearly polarized light component among polarized components included in the illumination light beam from the light source device 110B as it is, and reflects the other linearly polarized light component in the direction perpendicular to the illumination optical axis 100Bax. The polarization converting section 162 also has a reflecting layer that reflects the other linearly polarized light component reflected on the polarization separating layer in the direction parallel to the illumination optical axis 100Bax. The polarization converting section 162 further has a phase plate that performs polarization conversion so as to properly arrange a linearly polarized light component that is any one of the one linearly polarized light component transmitted through the polarization separating layer and the other linearly polarized light component reflected on the reflecting layer.

The light emitting surface of the integrator rod 160 has a planar shape constructed by “a rectangular shape of the longitudinal size along the y-axis direction: the transversal size along the x-axis direction=1:4” compressed in the longitudinal direction.

Thus, the projector 1006 in accordance with the fourth exemplary embodiment differs from the projector 1000 in accordance with the first exemplary embodiment in the construction of the illuminating device. However, similar to the case of the projector 1000 in accordance with the first exemplary embodiment, the projector 1006 has an unillustrated illuminating device driving circuit that controls the light amount of the illumination light beam emitted from the light source device 110B in time on the basis of the output signal of an unillustrated rotating state detecting sensor. Therefore, the illuminance difference generated when the rotating prism 770 is rotated at a constant rotating speed is reduced. Thus, more uniform display can be performed on the entire screen SCR. Namely, uniform in-plane display characteristics are provided.

As mentioned above, the projector 1006 in accordance with the fourth exemplary embodiment is constructed by arranging the illuminating device driving circuit that controls the light amount of the illumination light beam emitted from the light source device 110B in time on the basis of the output signal of the rotating state detecting sensor. However, similar to the case of the projector 1002 in accordance with the second exemplary embodiment, the projector 1006 may also be constructed by arranging the illuminating device driving circuit that controls the light amount of the illumination light beam emitted from the light source device 110B on the basis of a synchronous signal from an image processing circuit.

Accordingly, since the projector 1006 in accordance with the fourth exemplary embodiment has a construction similar to that of each of the projectors 1000, 1002 in accordance with the first or second exemplary embodiment except for the construction of the illuminating device, the projector 1006 has effects similar to those in the case of each of the projectors 1000, 1002 in accordance with the first or second exemplary embodiment

### Fifth Exemplary Embodiment

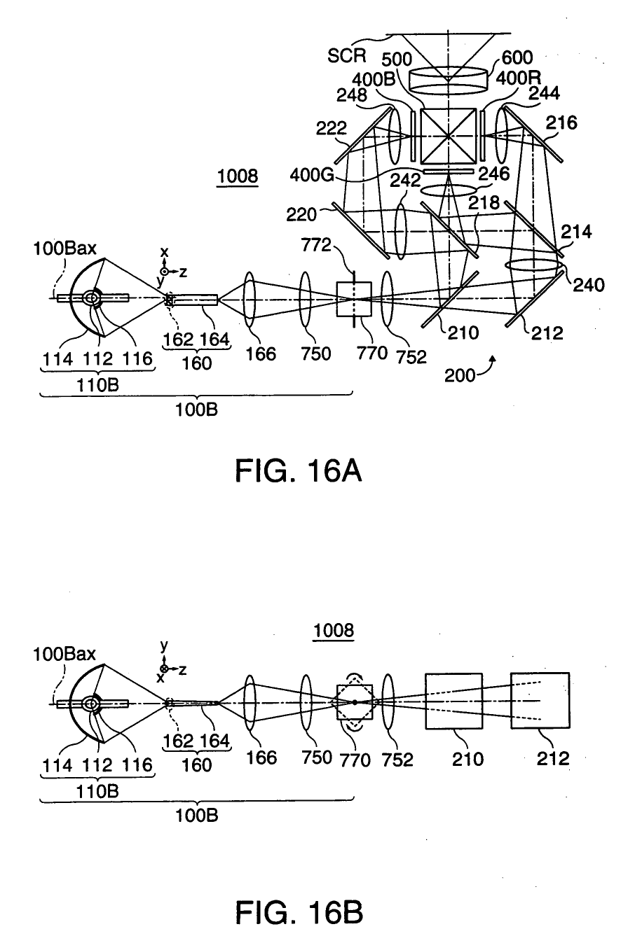

FIG. 16 is a view showing the optical system of a projector 1008 in accordance with a fifth exemplary embodiment. FIG. 16A is a view in which the optical system of the projector 1008 is seen from the upper side. FIG. 16B is a view in which the optical system of the projector 1008 is seen from the lateral side.

The projector 1008 in accordance with the fifth exemplary embodiment basically has a construction similar to that of the projector 1006 in accordance with the fourth exemplary embodiment, but differs from the projector 1006 in accordance with the fourth exemplary embodiment in the arranging position of the rotating prism and the existence of the light shielding member as shown in FIGS. 16A and 16B. Namely, in the projector 1008 in accordance with the fifth exemplary embodiment, the rotating prism 770 is arranged in a position optically approximately conjugate with respect to a light emitting surface of the integrator rod 160 and the liquid crystal devices 400R, 400G, 400B. Further, in accordance with this arrangement, no light shielding member is arranged in the projector 1008 in accordance with the fifth exemplary embodiment

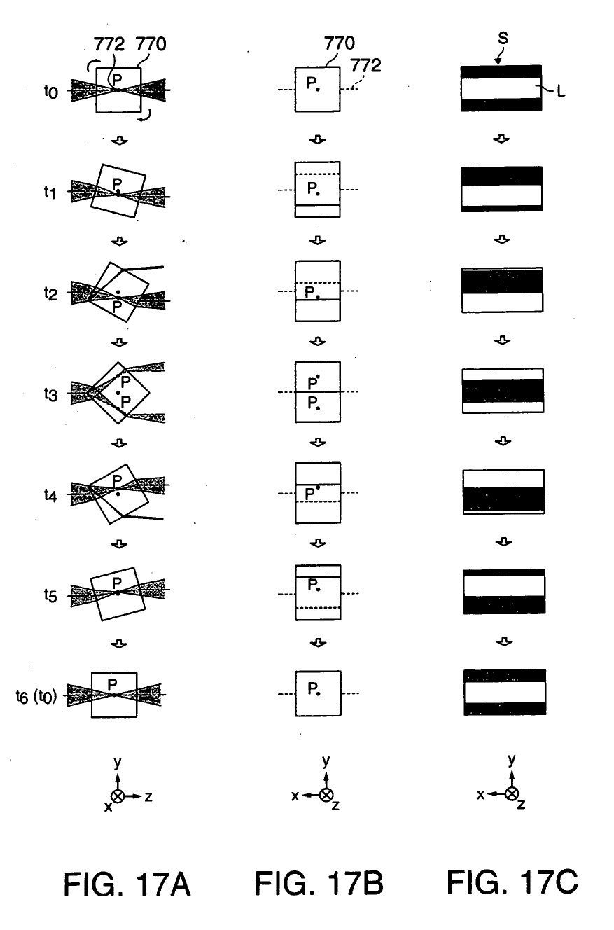

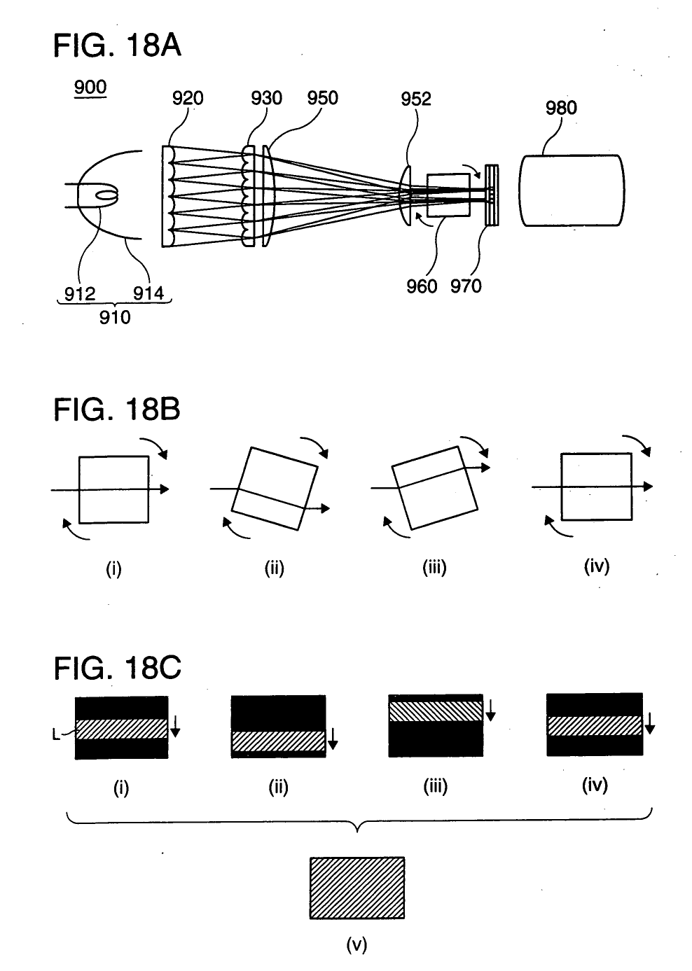

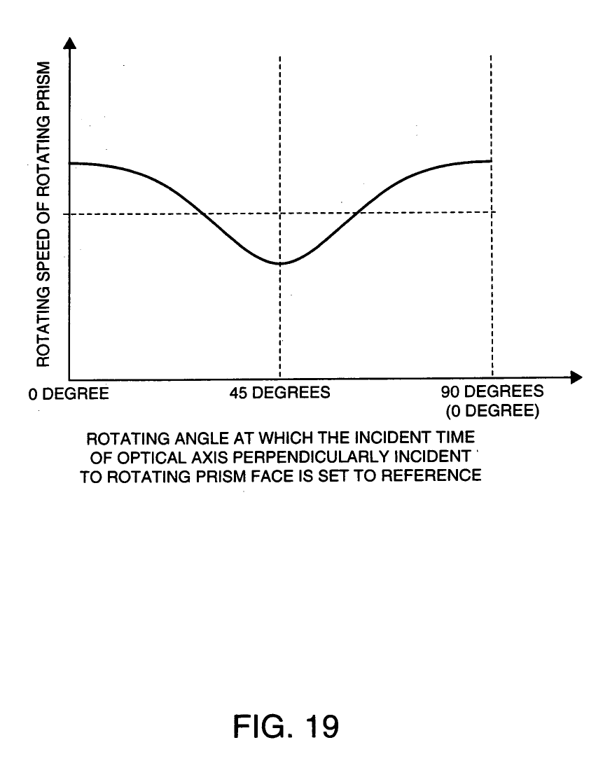

FIG. 17 is a view showing the relation between the rotation of the rotating prism 770 and an illuminating state on the liquid crystal devices 400R, 400G, 400B. FIG. 17A is a cross-sectional view when the rotating prism 770 is seen along a rotating axis 772. FIG. 17B is a view when the rotating prism 770 is seen along the illumination optical axis 100Bax. FIG. 17C is a view showing the illuminating state of the illumination light beam L on the image forming area S of the liquid crystal devices 400R, 400G, 400B.

As shown in FIGS. 17A to 17C, when the rotating prism 770 is rotated, predetermined refraction is performed by a light transmissive surface of the rotating prism 770 with respect to light emitted from an image P of a virtual central point of the light emitting surface of the integrator rod 160 on the illumination optical axis 100Bax. As a result, the light illuminating area and the light non-illuminating area are sequentially scrolled in the image forming area S of the liquid crystal devices 400R, 400G, 400B.

Therefore, in accordance with the projector 1008 in the fifth exemplary embodiment, similar to the case of the projector 1006 in accordance with the fourth exemplary embodiment, the illumination light beam L is scanned on the image forming area S of the liquid crystal devices 400R, 400G, 400B by rotating the rotating prism 770. As a result, light is intermittently interrupted if an arbitrary point in the image forming area S of the liquid crystal devices 400R, 400G, 400B is noticed. Therefore, moving picture display quality are improved and excellent moving picture display quality are provided.

Thus, the projector 1008 in accordance with the fifth exemplary embodiment differs from the projector 1006 in accordance with the fourth exemplary embodiment in the arranging position of the rotating prism and the existence of the light shielding member. However, similar to the case of the projector 1006 in accordance with the fourth exemplary embodiment, the projector 1008 has an unillustrated illuminating device driving circuit that controls the light amount of the illumination light beam emitted from the illuminating device 100B in time. Therefore, the illuminance difference generated when the rotating prism 770 is rotated at a constant rotating speed is reduced. Thus, more uniform display can be performed on the entire screen SCR. Namely, uniform in-plane display characteristics are provided.

Therefore, the projector 1008 in accordance with the fifth exemplary embodiment becomes a projector having effects similar to those in the case of the projector 1006 in accordance with the fourth exemplary embodiment, and having excellent moving picture display quality and uniform in-plane display characteristics, and raising no manufacture cost and no electric power consumption.

As mentioned above, the exemplary projectors of the invention have been explained on the basis of the above respective exemplary embodiments, but the invention is not limited to each of the above exemplary embodiments. The invention can also be embodied in various modes in the scope not departing from the gist of the invention. For example, the invention can also be modified as follows.

In the projectors 1000 to 1008 of the above respective exemplary embodiments, the illuminating devices 100, 100B having the light emitting tube 112 are used. However, the invention is not limited to this case, but the illuminating device having LED can also be used. In this case, it is sufficient to construct the illuminating device driving circuit so as to control the light emitting amount of the LED.

In the projectors 1000 to 1004 of the above first to third exemplary embodiments, “hie rectangular shape of the longitudinal size: the transversal size=1:4” is used as the planar shape of the first small lens 122 of the first lens array 120, but the invention is not limited to this case. For example, it is also possible to preferably use “the rectangular shape of the longitudinal size: the transversal size=9:32”, “the rectangular shape of the longitudinal size: the transversal size=3:8”, etc.

In the projectors 1006, 1008 of the above fourth and fifth exemplary embodiments, “the rectangular shape of the longitudinal size: the transversal size=1:4” is used as the planar shape of the light emitting surface of the integrator rod 160, but the invention is not limited to this case. For example, it is also possible to preferably use “the rectangular shape of the longitudinal size: the transversal size=9:32”, “the rectangular shape of the longitudinal size: the transversal size=3:8”, etc.

The projectors 1000 to 1006 of the above first to fourth exemplary embodiments use the light shielding member having the opening having the planar shape of “the rectangular shape of the longitudinal size along the y-axis direction: the transversal size along the x-axis direction=1:4” as the light shielding member 700, but the invention is not limited to this case. For example, it is also possible to use a light shielding member having the opening having the planar shape of “the rectangular shape of the longitudinal size along the y-axis direction: the transversal size along the x-axis direction=9:32”. Further, when the first small lens of the first lens array is a small lens having another planar shape except for the planar shape of “the rectangular shape of the longitudinal size along the y-axis direction: the transversal size along the x-axis direction=1:4”, it is also possible to use a light shielding member having an opening having a planar shape similar to the planar shape of this small lens. Further, when the integrator rod is an integrator rod having the light emitting face of another planar shape except for the planar shape of “the rectangular shape of the longitudinal size along the y-axis direction: the transversal size along the x-axis direction=1:4”, it is also possible to use a light shielding member having an opening having a planar shape similar to the planar shape of the light emitting surface of this integrator rod.

In the projectors 1000 to 1004 of the above first to third exemplary embodiments, the light source device having the ellipsoidal reflector 114, the light emitting tube 112 having a light emitting center in the vicinity of the first focal point of the ellipsoidal reflector 114, and the parallelization lens 118 is used as the light source device 110. However, the invention is not limited to this case. It is also possible to use a light source device having a parabolic reflector and a light emitting tube having the light emitting center in the vicinity of the focal point of the parabolic reflector.

In the projectors 1000 to 1008 of the above respective exemplary embodiments, the light source device having the auxiliary mirror 116 arranged in the light emitting tube 112 is used as the light source devices 110, 110B, but the invention is not limited to this case. It is also possible to use a light source device in which no auxiliary mirror is arranged in the light emitting tube.

In each of the above exemplary embodiments, the projectors using three liquid crystal devices 400R, 400G, 400B are illustrated and explained, but the invention is not limited to this case. The invention can also be applied to a projector using one, two, four or more liquid crystal devices.

In the projectors 1000 to 1008 of the above respective exemplary embodiments, the liquid crystal device is used as an electro-optic modulator, but the invention is not limited to this case. It is sufficient to generally modulate incident light in accordance with image information as the electro-optic modulator, and a micro mirror type optical modulator, etc. may also be utilized. For example, DMD (digital micro mirror device) (a trademark of the TI corporation) can be used as the micro miner type optical modulator.

The invention can also be applied to a front projecting type projector for projecting a projecting image from an observing side, and a rear projecting type projector for projecting the projecting image from the side opposed to the observing side.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

The priority applications Numbers JP2005-043518 upon which this patent application is based is hereby incorporated by reference.

What is claimed is:

1. A projector comprising:
an electro-optic modulator that modulates an illumination light beam in accordance with image information;
a projecting optical system that projects the illumination light beam modulated by the electro-optic modulator,
an illuminating device that emits the illumination light beam having a sectional shape compressed in the other direction so as to illuminate an entire image forming area with respect to one direction in the image forming area of the electro-optic modulator and illuminate one portion of the image forming area with respect to the other direction;
a rotating prism rotated at a constant speed and scanning the illumination light beam from the illuminating device along the other direction in the image forming area of the electro-optic modulator, and
an illuminating device driving circuit that controls the light amount of the illumination light beam emitted from the illuminating device so as to reduce an illuminance difference generated by changing the scanning speed of the illumination light beam on the image forming area in the electro optic modulator.

2. The projector according to claim 1, further comprising:
a rotating state detecting sensor that detects a rotating state of the rotating prism, the illuminating device driving circuit controlling the light amount of the illumination light beam emitted from the illuminating device on the basis of an output signal of the rotating state detecting sensor.

3. The projector according to claim 1, further comprising:
an image processing circuit that processes image information, the rotating prism being constructed so as to be rotated at a constant speed on the basis of a synchronous signal from the image processing circuit, and the illuminating device driving circuit controlling the light amount of the illumination light beam emitted from the illuminating device on the basis of the synchronous signal from the image processing circuit.

4. The projector according to claim 1, wherein
the illuminating device including a light source device having a light emitting tube and a reflector and emitting the illumination light beam on the side of an illuminated area; a first lens array having plural first small lenses that divides the illumination light beam emitted from the light source device into plural partial light beams; a second lens array having plural second small lenses corresponding to the plural first small lenses of the first lens array, and a superposing lens that superposes each partial light beam emitted from the plural second small lenses of the second lens array on an illumination area, the first small lens having a planar shape compressed in the other direction.

5. The projector according to claim 1, wherein
the illuminating device including a light source device having a light emitting tube and an ellipsoidal reflector and emitting a convergent illumination light beam on the side of an illuminated area; and an integrator rod that converts the illumination light beam from the light source device into an illumination light beam having a more uniform intensity distribution, and a light emitting surface of the integrator rod having a planar shape compressed in the other direction.

6. The projector according to claim 4, wherein
the illuminating device driving circuit controlling the light emitting amount of the light emitting tube.

7. The projector according to claim 5, wherein
the illuminating device driving circuit controlling the light emitting amount of the light emitting tube.

8. The projector according to claim 1, wherein
the illuminating device having an LED, and the illuminating device driving circuit controlling the light emitting amount of the LED.

9. The projector according to claim 1, further comprising:
a light shielding member that shapes the sectional shape of the illumination light beam, the light shielding member being arranged in a position optically approximately conjugate with respect to the electro-optic modulator.

10. The projector according to claim 1, wherein
the rotating prism being arranged in a position optically approximately conjugate with respect to the electro-optic modulator.
